(19) United States
(12) Patent Application Publication
(10) Pub. No.: US 2015/0152739 A1
(43) Pub. Date: Jun. 4, 2015

(54) TURBINE BLADE RAIL DAMPER

(71) Applicant: United Technologies Corporation, Hartford, CT (US)

(72) Inventors: Jeff H. Miller, Simi Valley, CA (US); Steven P. Grota, Thousand Oaks, CA (US)

(73) Assignee: UNITED TECHNOLOGIES CORPORATION, Hartford, CT (US)

(21) Appl. No.: 14/590,161

(22) Filed: Jan. 6, 2015

Related U.S. Application Data
(63) Continuation of application No. 13/279,473, filed on Oct. 24, 2011, now Pat. No. 8,951,013.

(51) Int. Cl. F01D 5/22; F01D 25/06; F01D 5/10

(52) U.S. Cl. CPC F01D 5/225; F01D 5/10; F01D 25/06; F05D 2260/96

(57) ABSTRACT

A device for damping of vibratory energy in the blades of rotor assemblies during operation where the blades have a shroud attached thereto with at least one sealing rail extending radially outward from the shroud to an outer diameter surface. A damper element is attached to the turbine blade sealing rail extending radially inward from the rail outer diameter surface along rail sides to maintain the damper element out of the flow of gas and positioned at a radial location on the blade for damping.

### CROSS-REFERENCE TO RELATED APPLICATION(S)

This is a continuation of U.S. patent application Ser. No. 13/279,473, entitled “TURBINE BLADE RAIL DAMPER”, filed Oct. 24, 2011.

### BACKGROUND

This invention relates to rotor blades and specifically to the mechanical damping of vibratory energy in the blades of rotor assemblies during operation. Rotor assemblies are used in a variety of turbo-machines, such as turbines and compressors. During operation, fluid forces induce vibratory stresses on the blades, resulting in high cycle fatigue and potential failure of the blades. Dampers, commonly frictional dampers, are utilized to reduce the magnitude of these dynamic stresses, thereby increasing operational life of the blades.

Typically the most effective frictional dampers are located on the turbine blade shroud. The shroud is located at the radial tip of the rotor blade adjacent the stationary housing. During operation, centrifugal forces urge the damper into frictional contact with its adjacent blade shroud. This contact reduces the relative motion between the adjacent blades, thereby reducing the vibratory stresses on the blades during operation. Frictional damping is effective so long as relative motion exists between the damper and the blade. When the rotor speed becomes high, typical flat plate shroud dampers become too heavy and the frictional damper sticks to the shroud due to friction thereby reducing its effectiveness. Typical lighter weight damper designs consist of loss fitting rivets. These rivets are hard to form due to the many tight tolerance features required and they are exposed to the main gas flow.

Other efforts to reduce vibrational damage not only are structurally deficient in affecting the clearances of the shroud, they are subject to fatigue that further reduces their effectiveness.

Conventional shrouds typically include one or more sealing rails that extend radially outward from the shroud in close proximity to the stationary housing and typically extend continuously across the top surface of the shroud between first and second circumferential sides. Typical previous shroud frictional dampers are retained by extra features added to the shroud. These added features are located on the shroud at the furthest distance from blade which increases the shroud overhung weight. These added features increase the centrifugal induced bending stress in the shroud which may result in potential failure of the rotor assembly due to high cycle fatigue. To counteract this, the shroud thickness must be increased. This increase in shroud thickness also results in higher centrifugal stress in the blade at the blade's two critical locations, the blade shank and firtree.

What is needed is a way to place any damper out of the main gas flow of turbo-machines without adversely affecting the function of the shroud.

### SUMMARY

The present invention relates to a damper arrangement on the sealing rail of turbo-machine shrouds where the damper in the rail is outside of the main gas flow. This invention uses the existing rail and requires no modification to the shroud to retain the damper. The rail damper comprises a shim stock having its ends oriented to function with specific shroud rail configurations. The present invention does not require any special retainment features. Retainment features add weight to the shroud and result in lower shroud and blade safety factors.

### BRIEF DESCRIPTION OF THE DRAWINGS

FIG. 1 is a perspective view illustrating one embodiment of the present invention in a rotor assembly used in turbo-machines, showing turbine blades having shrouds with rails and damper elements.

FIG. 2a is a perspective view of the embodiment in a shroud rail.

FIG. 2b is an enlarged perspective view of the damper used in FIG. 1.

FIG. 2c is an enlarged perspective view of the slot in the shroud and rail in FIG. 2a.

FIG. 2d is an end view of the damper in the slot of FIG. 2c.

FIG. 3a perspective view of another embodiment of this invention in a shroud rail.

FIG. 3b is an enlarged perspective view of the damper used in FIG. 3a.

FIG. 3c is an enlarged perspective view of the slot in the shroud and rail in FIG. 3a.

FIG. 3d is an end view of the damper in the slot of FIG. 3c.

FIG. 4a perspective view of another embodiment of this invention in a shroud rail.

FIG. 4b is an enlarged perspective view of the damper used in FIG. 4a.

FIG. 4c is an enlarged perspective view of the slot in the shroud and rail in FIG. 4a.

FIG. 4d is an end view of the damper in the slot of FIG. 4c.

FIG. 5a perspective view of another embodiment of this invention in a shroud rail.

FIG. 5b is an enlarged perspective view of the damper used in FIG. 5a.

FIG. 5c is an enlarged perspective view of the slot in the shroud and rail in FIG. 5a.

FIG. 5d is an end view of the damper in the slot of FIG. 5c.

FIG. 6a perspective view of another embodiment of this invention in a shroud rail.

FIG. 6b is an enlarged perspective view of the damper used in FIG. 6a.

FIG. 6c is an enlarged perspective view of the slot in the shroud and rail in FIG. 6a.

FIG. 6d is an end view of the damper in the slot of FIG. 6c.

FIG. 7a perspective view of another embodiment of this invention in a shroud rail.

FIG. 7b is an enlarged perspective view of the damper used in FIG. 7a.

FIG. 7c is an enlarged perspective view of the slot in the shroud and rail in FIG. 7a.

FIG. 7d is an end view of the damper in the slot of FIG. 7c.

FIG. 8a perspective view of another embodiment of this invention in a shroud rail.

FIG. 8b is an enlarged perspective view of the damper used in FIG. 8a.

FIG. 8c is an enlarged perspective view of the slot in the shroud and rail in FIG. 8a.

FIG. 8d is an end view of the damper in the slot of FIG. 68c.

### DETAILED DESCRIPTION

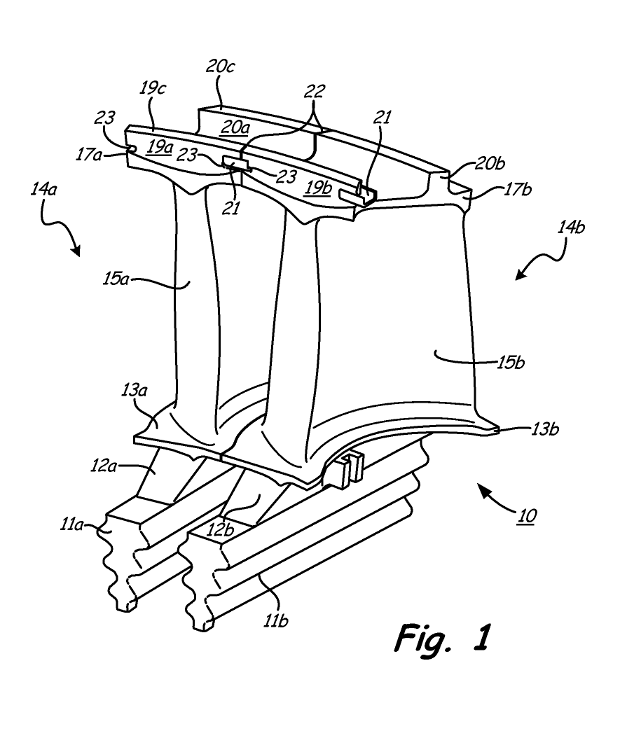

FIG. 1 shows a perspective view of an assembly 10, generally, of a pair of turbine blades 14a and 14b of a turbo-machine such as a gas turbine engine. Blades 14a and 14b include firtrees 11a and 11b, blade shanks 12a and 12b, platforms 13a and 13b, airfoils 15a and 15b, shrouds 17a and 17b, upstream rails 19a and 19b, and downstream rails 20a and 20b, respectively. Airfoils 15a and 15b extend radially out from platforms 13a and 13b to shrouds 17a and 17b. Shrouds 17a and 17b include upstream rails 19a and 19b and downstream rails 20a and 20b, which extend radially outward in close proximity to a stationary housing (of conventional design, not shown). Upstream rails 19a and 19b and downstream rails 20a and 20b typically extend continuously across the top surface of shrouds 17a and 17b between first and second radial faces. Rail damper 21 is placed on upstream rails 19a and 19b at a point remote from the main gas flow in the turbo-machine. Damper 21 is radially inward from the outer surface 19c of the upstream rail 19a. Damper 21 is shown bridging the gap between successive upstream rail portions of 19a and 19b at junction 22.

FIG. 1 shows two blades 14a and 14b to illustrate the positioning of damper 21 at junction 22. Also shown is another damper 21 at the right end of rail 19b for positioning between rail 19b and a corresponding upstream rail of a blade that will be positioned adjacent blade 19b.

Damper element 21 may be any shape that provides a fit on the rail, with a generally “U” shape being shown. The sides of the “U” shape may extend radially up or down, depending on the configuration of upstream rails 19a and 19b. The use of the “U” shape allows for simple manufacture and installation. Damper 21 may be any material, such as steel or other metals, ceramics and other materials. Damper 21 material should be selected to have a light weight when possible.

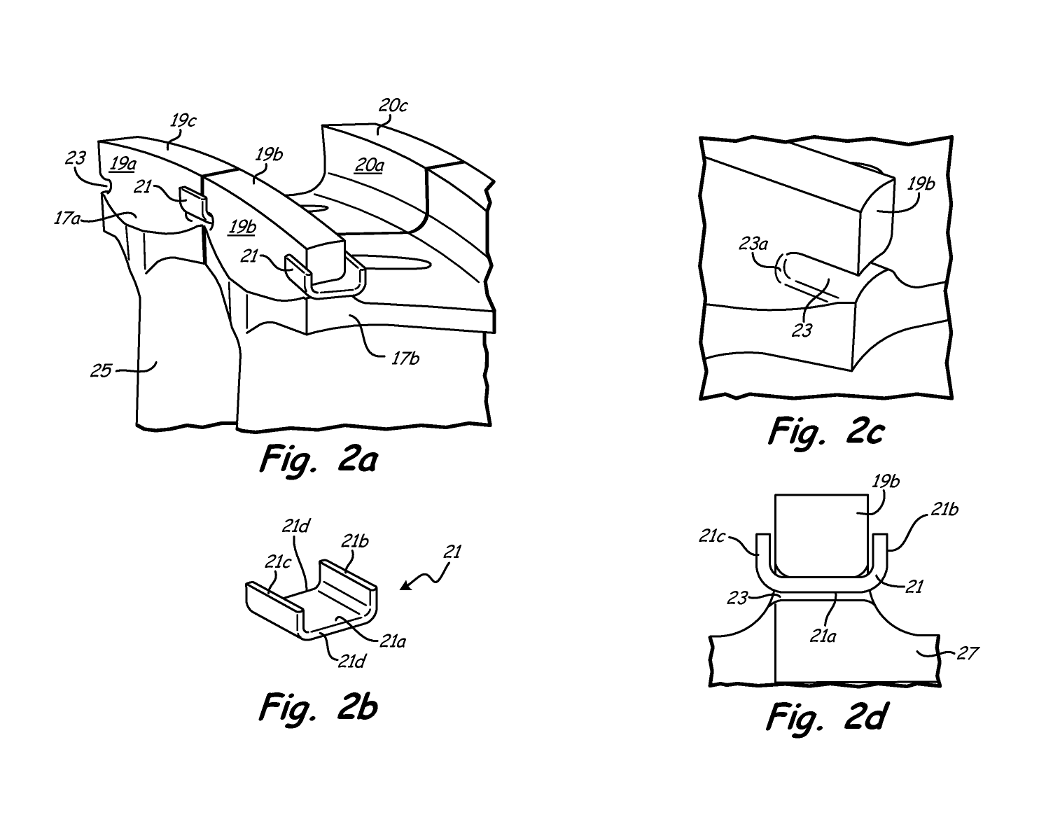

FIG. 2a is an enlarged perspective view showing the details of the relationship between shrouds 17a and 17b and upstream rails 19a and 19b. Damper 21 is seen in FIG. 2b as having fully rounded end faces 21d, a flat center portion 21a, and side portions 21b and 21c. FIG. 2c shows damper slot 23 with a fully rounded end face 23a to accept and hold damper 21. FIG. 2d shows damper 21 in slot 23 in the operating position where side portions 21b and 21c extend up to engage upstream rail 19b.

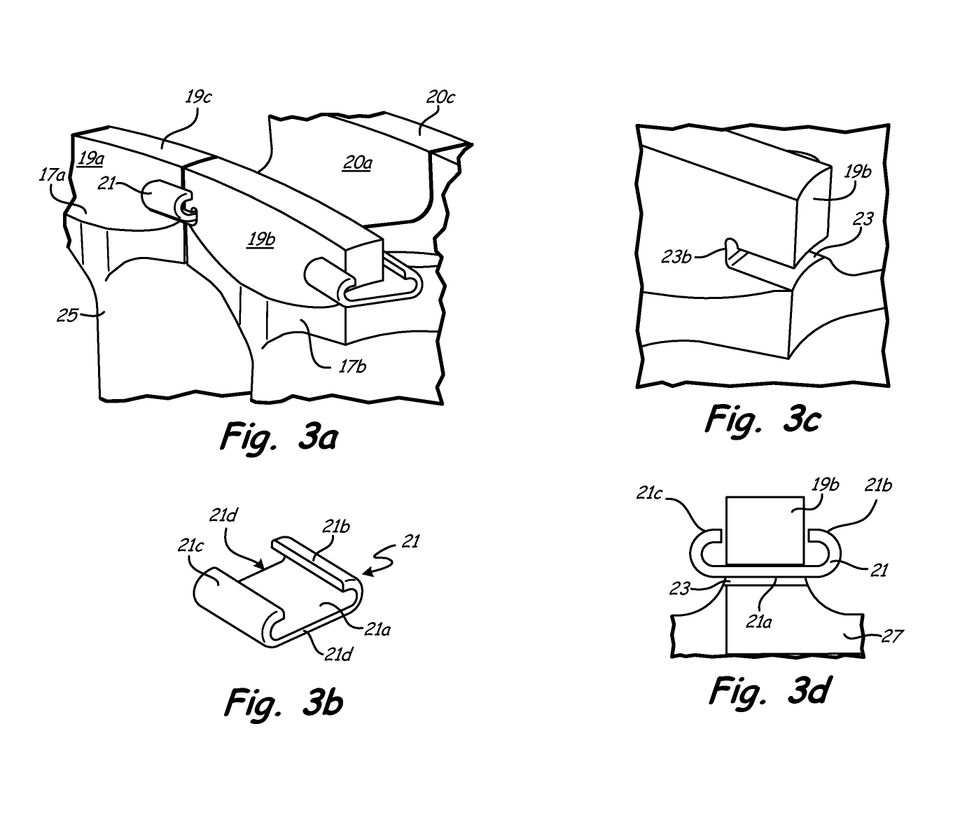

FIG. 3a is an enlarged perspective view showing the details of an alternative relationship between shrouds 17a and 17b and upstream rails 19a and 19b. Damper 21 is seen in FIG. 3b as having fully rounded end faces 21d, a flat center portion 21a, and c-shaped side portions 21b and 21c. FIG. 3c shows damper slot 23 with an undercut end face 23b to accept and hold damper 21. FIG. 3d shows damper 21 in slot 23 in the operating position where side portions 21b and 21c engage upstream rail 19b.

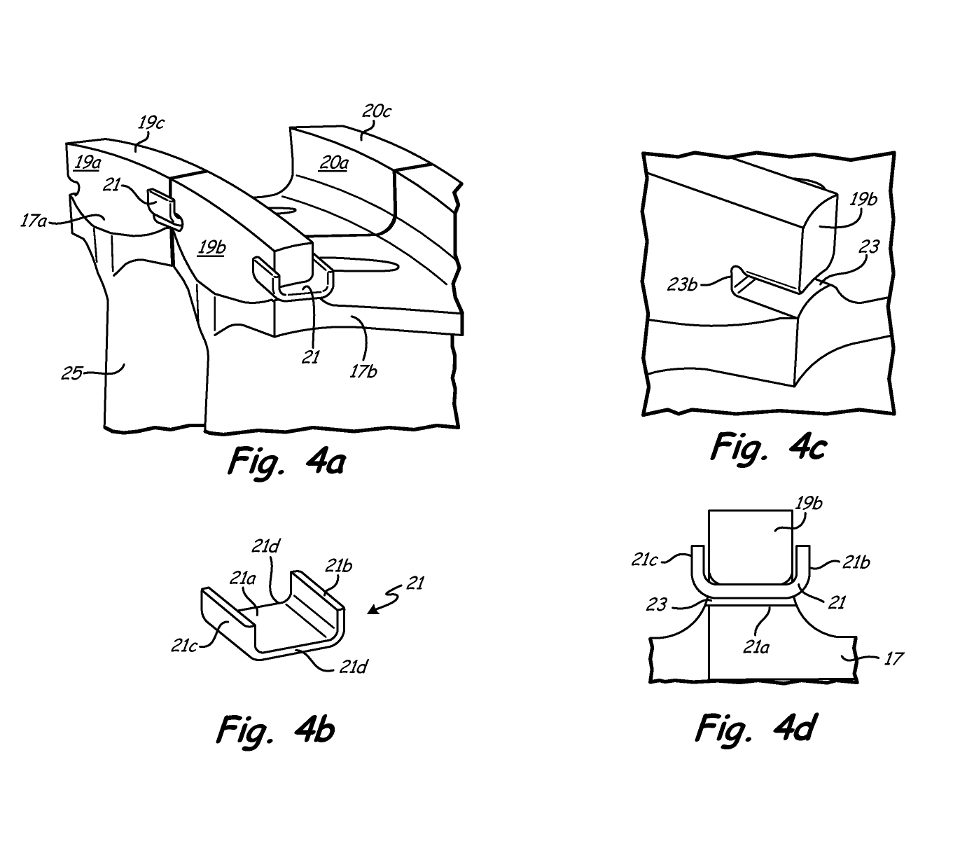

FIG. 4a is an enlarged perspective view showing the details of another alternative relationship between shrouds 17a and 17b and upstream rails 19a and 19b. Damper 21 is seen in FIG. 4b as having fully rounded end faces 21d, a flat center portion 21a, and side portions 21b and 21c. FIG. 4c shows damper slot 23 with an undercut end face 23b to accept and hold damper 21. FIG. 4d shows damper 21 in slot 23 in the operating position where side portions 21b and 21c engage upstream rail 19b.

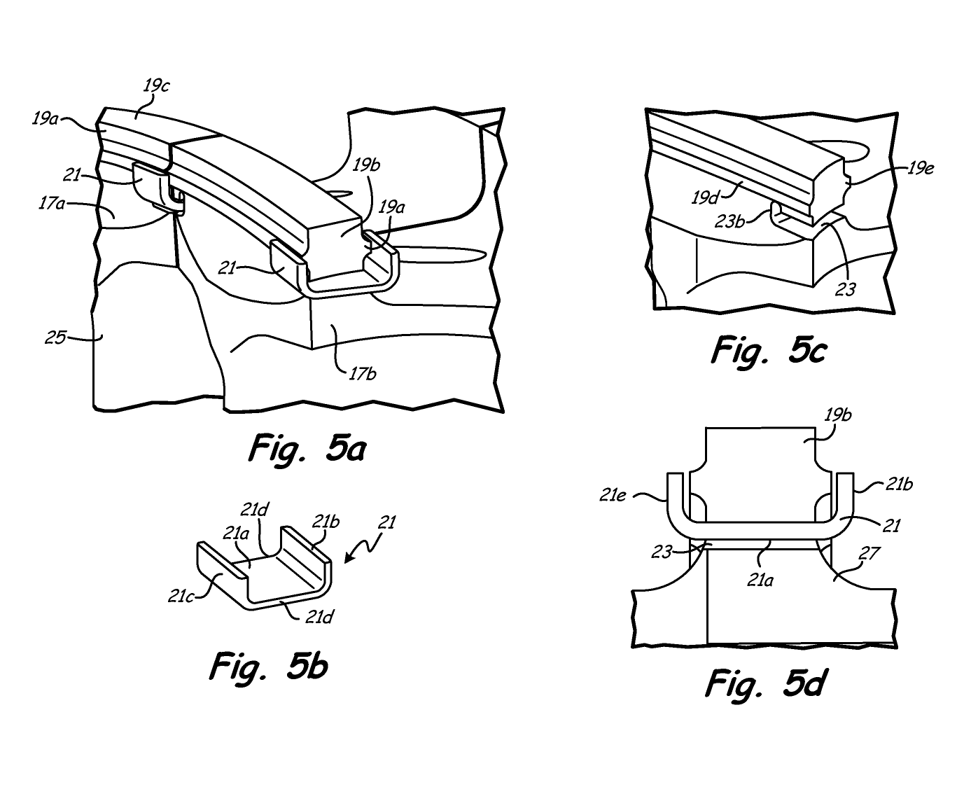

FIG. 5a is an enlarged perspective view showing the details of another alternative relationship between shrouds 17a and 17b and upstream rails 19a and 19b. Damper 21 is seen in FIG. 5b as having fully rounded end faces 21d, a flat center portion 21a, and side portions 21b and 21c having a size suitable to engage axial stops 19d and 19e. FIG. 5c shows damper slot 23 with an undercut end face 23b to accept and hold damper 21. FIG. 5d shows damper 21 in slot 23 in the operating position.

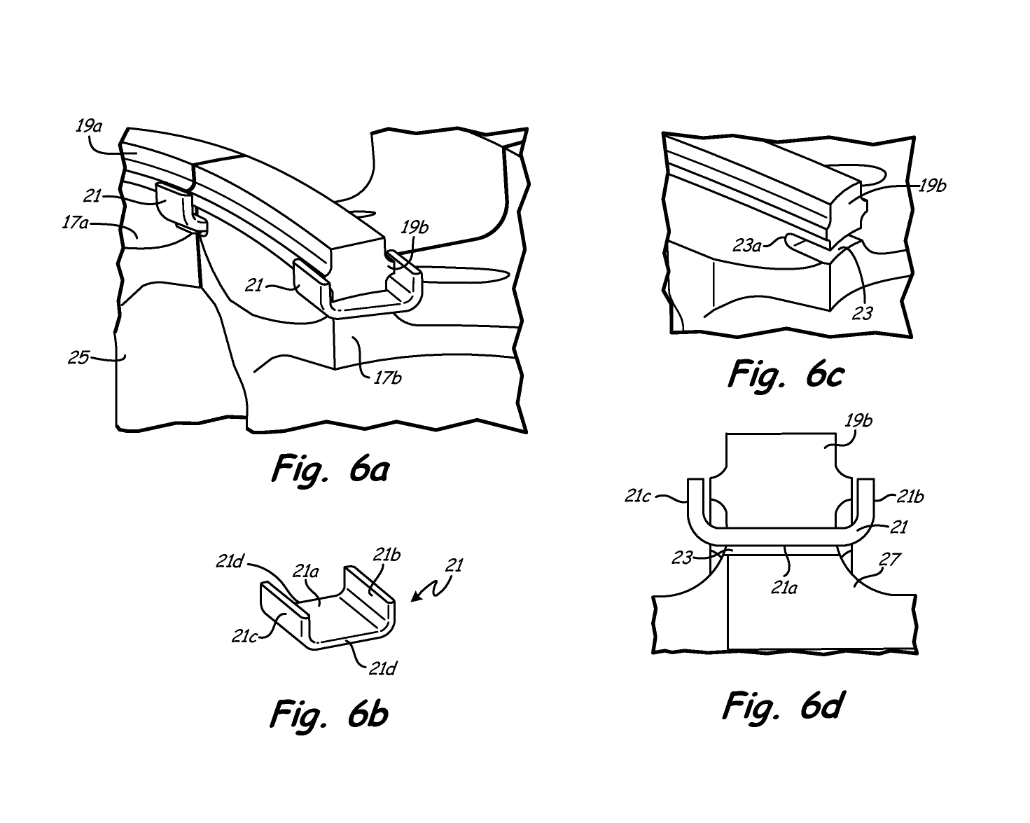

FIG. 6a is an enlarged perspective view showing the details of another alternative relationship between shrouds 17a and 17b and upstream rails 19a and 19b. Damper 21 is seen in FIG. 6b as having fully rounded end faces 21d, a flat center portion 21a and both ends 21b and 21c. FIG. 6c shows damper slot 23 with a round end face 23a to accept and hold damper 21. FIG. 6d shows damper 21 in slot 23 in the operating position where damper ends 21b and 21c engage upstream rail 19b.

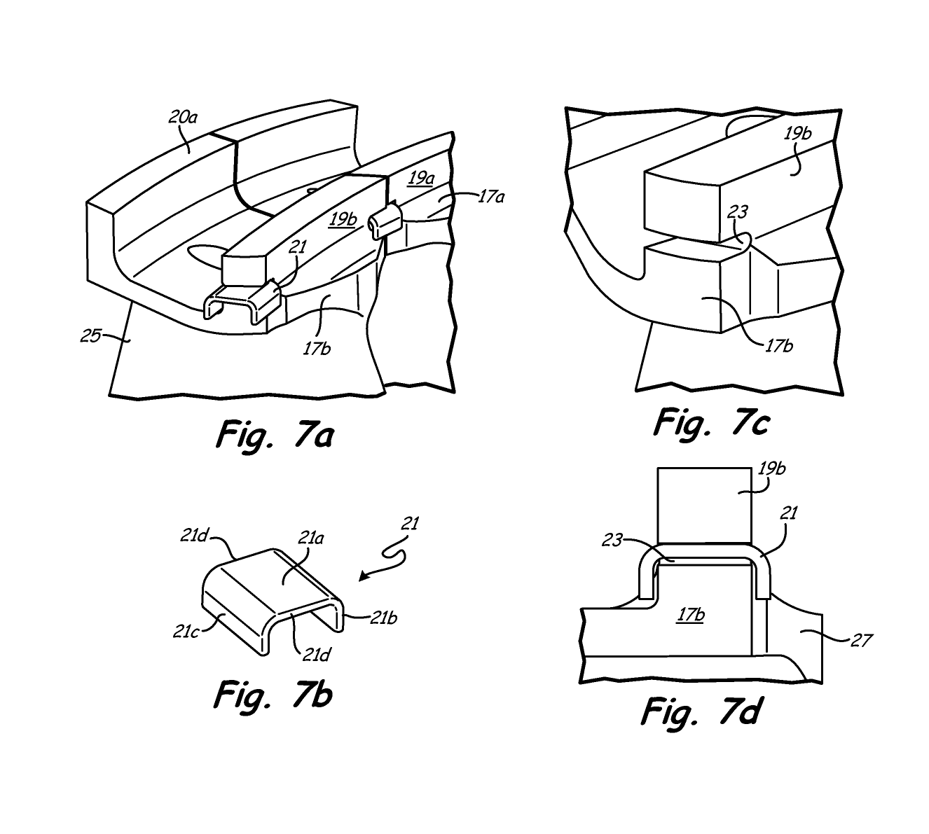

FIG. 7a is an enlarged perspective view showing the details of another alternative relationship between shrouds 17a and 17b and upstream rails 19a and 19b. Damper 21 is seen in FIG. 7b as having fully rounded end faces 21d, a flat center portion 21a, and side portions 21b and 21c. FIG. 7c shows damper slot 23 with a fully rounded end face where portions of shroud 17a and 17b are relieved to accept and hold side portions 21b and 21c. FIG. 7d shows damper 21 in slot 23 in the operating position where side portions 21b and 21c extend downward to engage upstream rail 19b.

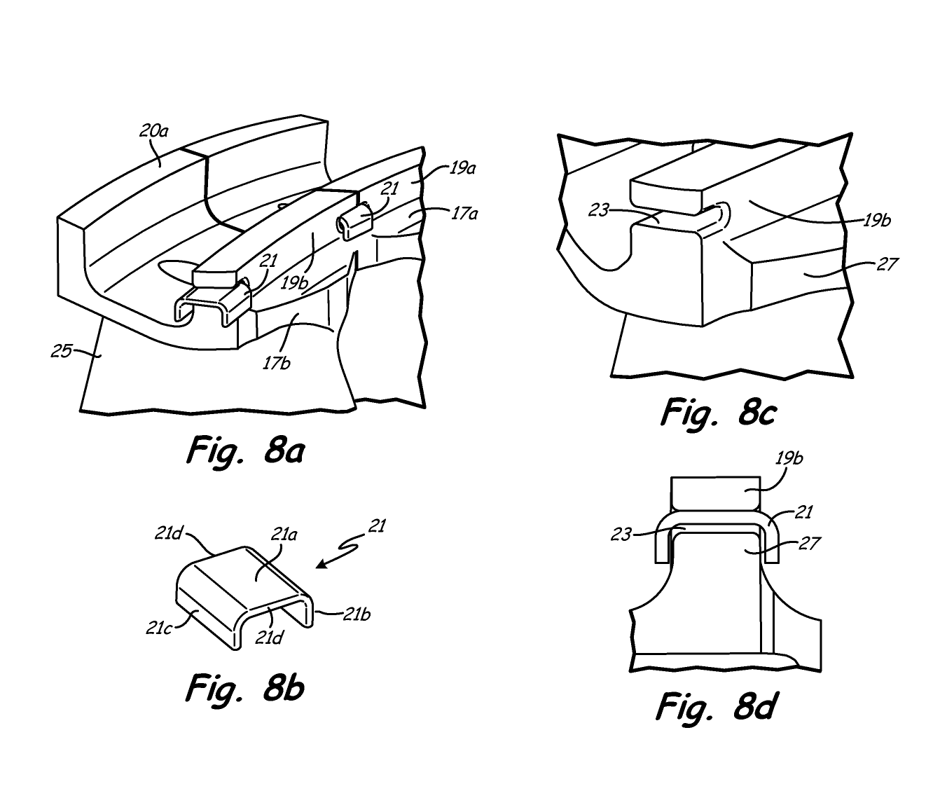

FIG. 8a is an enlarged perspective view showing the details of another alternative relationship between shrouds 17a and 17b and upstream rails 19a and 19b. Damper 21 is seen in FIG. 8b as having fully rounded end faces, a flat center portion 21a, and side portions 21b and 21c. FIG. 8c shows damper slot 23 wider to accept and hold side portions 21b and 21c without having any part of shrouds 17a and 17b being removed. FIG. 8d shows damper 21 in slot 23 in the operating position where side portions 21b and 21c extend downward to engage upstream rail 19b.

In all of the embodiments shown herein, the damper is designed to engage the sealing rail of a shroud facing inward from the rail outer surface to maintain the damper element out of the flow of gas and at the most effective radial location on the blade. Damping is affected without any lessening of the functionality of the rails or the shroud. Similar dampers may also be placed on downstream rails since alteration of the shroud is not needed.

The invention has been shown in association with a firtree bladed rotor. The invention is also suitable for use with other rotor configurations such as an integrally bladed rotor, for example.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A device for damping vibratory energy in a rotor assembly during operation, comprising:
a first turbine blade having a shroud with a first sealing rail, the first sealing rail having a first slot at a radial face of the first sealing rail, wherein the first slot has radially inner and radially outer surfaces that are generally perpendicular to the radial face of the first sealing rail;
a second turbine blade adjacent the first blade and having a shroud with a second sealing rail, the second sealing rail having a second slot at a radial face of the second sealing rail such that the first slot is adjacent and opposing the second slot, wherein the second slot has radially inner and radially outer surfaces that are generally perpendicular to the radial face of the second sealing rail, and wherein the radial face of the first sealing rail abuts the radial face of the second sealing rail; and
a damper element positioned in and extending between the first and second slots.

2. The device of claim 1, wherein the damper element is made from metal or ceramic.

3. The device of claim 1, wherein the first and second slots at the radial faces of the first and second turbine blades are positioned between the shroud and an outer surface of the first and second sealing rails to keep the damper element out of the flow of gas.

4. The device of claim 1, wherein the damper element is generally “U” shaped, and wherein the “U” has a flat center portion that engages an end face-of the first or second slot, and wherein the “U” has a side portion that extends along an axial face of the first sealing rail.

5. The device of claim 4, wherein the side portion of the “U” extends radially outward on the face of the first sealing rail.

6. The device of claim 4, wherein the side portion of the “U” extends radially inward on the face of the first sealing rail.

7. The device of claim 1, wherein the first or second slot is undercut at an end face of the slot to further engage the damper element.

8. The device of claim 1, wherein the first sealing rail further includes an axial stop on an upstream or downstream face of the first sealing rail for engaging the damper element.

9. A device for damping vibratory energy in a rotor assembly during operation, comprising:
a first turbine blade comprising:
a first shroud;
a first sealing rail extending along the first shroud, the first sealing rail comprising:
a first radial face;
a first inner surface extending into the first sealing rail from the first radial face;
a first outer surface radially offset from the first inner surface, wherein the first inner and outer surfaces extend into the first sealing rail from the first radial face; and
a first end face joining the first inner surface to the first outer surface, wherein the first inner surface, the first outer surface, and the first end face define a first slot;
a second turbine blade adjacent to the first turbine blade comprising:
a second shroud;
a second sealing rail extending along the second shroud, the second sealing rail comprising:
a second radial face;
a second inner surface extending into the second sealing rail from the second radial face;
a second outer surface radially offset from the second inner surface, wherein the second inner and outer surfaces extend into the second sealing rail from the second radial face; and
a second end face joining the second inner surface to the second outer surface, wherein the second inner surface, the second outer surface, and the second end face define a second slot; and
a damper element positioned in and extending between the first and second slots.

10. The device of claim 9, wherein the first and second slots are positioned between the shrouds of the first and second turbine blades and outer surfaces of the first and second sealing rails.

11. The device of claim 9, wherein the damper element is generally “U” shaped, the “U” shape defined by a flat center portion that engages the end face of the first or second slot and side portions extending from upstream and downstream sides of the flat center portion, wherein at least one of the side portions engages an upstream face or a downstream face of the first or second sealing rail.

12. The device of claim 11, wherein at least one side portion of the damper element extends radially outward along the upstream or downstream faces of the first and second sealing rails.

13. The device of claim 11, wherein at least one side portion of the damper element extends radially inward along the upstream or downstream faces of the first and second sealing rails.

14. The device of claim 9, wherein the first slot has an undercut extending along the first end face such that the damper element further engages the first slot.

15. The device of claim 9, wherein the first sealing rail further includes an axial stop on an upstream or downstream face of the first sealing rail for engaging the damper element.

16. A device for damping vibratory energy in a rotor assembly during operation, comprising:
a first sealing rail disposed at a radially outer periphery of a first turbine blade, the first sealing rail comprising
a first inner surface;
a first outer surface radially offset from the first inner surface; and
a first end surface joining the first inner surface to the first outer surface, wherein the first inner surface, the first outer surface, and the first end surface define a first slot;
a second sealing rail disposed at a radially outer periphery of a second turbine blade, the second sealing rail comprising:
a second inner surface;
a second outer surface radially offset from the second inner surface; and
a second end surface joining the second inner surface to the second outer surface, wherein the second inner surface, the second outer surface, and the second end surface define a second slot; and
a damper element positioned in and extending between the first and second slots, wherein the second turbine blade abuts the first turbine blade along a radial plane of the rotor assembly, and wherein the first and second slots extend from the radial plane into the first and second sealing rails respectively such that the first and second outer surfaces are generally perpendicular to the radial plane and the first and second end faces are generally parallel to the radial plane.

17. The device of claim 16, wherein the damper element is generally “U” shaped, and wherein the damper element has a center portion extending between the first inner and outer surfaces, a first side portion extending along a downstream face of the first sealing rail, and a second side portion extending along an upstream face of the first sealing rail.

18. The device of claim 16, wherein the first slot has a groove generally perpendicular to the first inner surface, and wherein the groove extends along the first end face such that the damper element further engages the first slot.

19. The device of claim 16, wherein the first sealing rail further includes an axial stop on an upstream or downstream face of the first sealing rail for engaging the damper element.

20. The device of claim 17, wherein the first and second side portions of the damper element extend radially outward along the upstream and downstream faces of the first and second sealing rails.
